(19) United States
(12) Patent Application Publication
(10) Pub. No.: US 2026/0060181 A1
(43) Pub. Date: Mar. 5, 2026

(54) KNOTTING SYSTEM FOR MULTI-CHAMBER AGRICULTURAL BALER

(71) Applicant: CNH Industrial America LLC, New Holland, PA (US)

(72) Inventors: Kevin Smith, Narvon, PA (US); Grant Garber, Strasburg, PA (US)

(73) Assignee: CNH Industrial America LLC, New Holland, PA (US)

(21) Appl. No.: 19/297,014

(22) Filed: Aug. 12, 2025

Related U.S. Application Data
(60) Provisional application No. 63/687,492, filed on Aug. 27, 2024.

(51) Int. Cl. A01F 15/08; A01F 15/04; A01F 15/14

(52) U.S. Cl. CPC A01F 15/0858; A01F 15/046; A01F 15/145; A01F 2015/0866

(57) ABSTRACT

An agricultural baler includes first and second bale chambers, wherein each bale chamber is capable of holding an individual bale of crop material. A first tying apparatus is assigned to the first chamber for tying and knotting a bale formed within the first chamber. A second tying apparatus is assigned to the second chamber for tying and knotting a bale formed within the second chamber. The first and second tying apparatuses are configured to be operated independently so as to accomplish tying and knotting of the bales in the first and second bales chambers at different times.

### CROSS REFERENCE TO RELATED APPLICATION

This application claims priority to U.S. Provisional Patent Application Ser. No. 63/687,492, filed Aug. 27, 2024, the contents of such application being incorporated herein by reference.

### FIELD OF THE INVENTION

The present invention relates to agricultural balers, and, more particularly, to a knotting system for a multi-chamber baler.

### BACKGROUND OF THE INVENTION

As is described in U.S. Pat. No. 11,672,206 to CNH America LLC, which is incorporated by reference in its entirety and for all purposes, agricultural harvesting machines, such as balers, are used to consolidate and package cut crop material so as to facilitate the storage and handling of the crop material for later use. A baler, such as a large square baler or round baler, picks up the crop material and forms it into bales. On a large square baler, a pickup unit at the front of the baler gathers the cut and windrowed crop material from the ground. The pickup unit includes a pickup roll, and optionally may include other components such as side shields, stub augers, wind guard, etc. A packer unit is used to move the crop material from the pickup unit to a duct or pre-compression chamber. The packer unit forms a wad of crop within the precompression chamber which is then transferred to a bale chamber. For purposes of discussion, the charge of crop material within the pre-compression chamber will be termed a “wad”, and the charge of crop material after being compressed within the main bale chamber will be termed a “flake”. Typically such a packer unit includes packer tines or forks to move the crop material from the pickup unit into the pre-compression chamber. Instead of a packer unit it is also known to use a rotor cutter unit which chops the crop material into smaller pieces. A stuffer unit transfers the wad of crop material in charges from the precompression chamber to the bale chamber. Typically such a stuffer unit includes stuffer forks which are used to move the wad of crop material from the pre-compression chamber to the bale chamber, in sequence with the reciprocating action of a plunger within the bale chamber.

When enough flakes have been added and the bale reaches a full (or other predetermined) size, a tying apparatus (which may include a yoke with a number of needles) is activated to transfer twine through the plunger behind the last compressed flake of the bale to knotters which are actuated to wrap and tie twine, cord or the like around the bale while it is still in the bale chamber. The twine is cut and the formed bale is ejected out the back of the baler as a new bale is formed.

Described above is a baler having a single bale chamber. However, for a baler having multiple bale chambers, for example, the bales in each chamber may not be formed at the same rate due to the uneven distribution of incoming crop along the transverse direction (width) of the baler. Accordingly, described herein is a tying system configured to tie the bales in each chamber at different times. In view of the foregoing, described herein are independently operated tying apparatuses for tying bales that are produced at different times by a multi-chamber baler.

### SUMMARY OF THE INVENTION

According to one aspect of the invention, an agricultural baler includes first and second bale chambers, wherein each bale chamber is capable of holding an individual bale of crop material. A first tying apparatus is assigned to the first chamber for tying and knotting a bale formed within the first chamber. A second tying apparatus is assigned to the second chamber for tying and knotting a bale formed within the second chamber. The first and second tying apparatuses are configured to be operated independently so as to accomplish tying and knotting of the bales in the first and second bales chambers at different times.

According to another aspect of the invention a method of operating an agricultural baler comprises independently operating the first and second tying apparatuses to accomplish tying and knotting of the bales in the first and second bales chambers at different times.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, elevational view of a baler utilizing a tying apparatus.

FIG. 2 is a diagrammatic view of a complete double-knotted loop and a partial double-knotted loop.

FIG. 3 is an enlarged, fragmentary, elevational view of a tying apparatus in mid-cycle.

FIG. 4 is a fragmentary, elevational view of cams on the drive shaft of the knotter for operating the slack take-up arm and the twine finger which assist during the tying operation.

FIG. 5 is a fragmentary, top plan and schematic view showing the multiple chambers and knotters of the baler.

It is noted that the figures depict the elements in schematic form and are not necessarily to scale.

### DETAILED DESCRIPTION OF THE INVENTION

Corresponding reference characters indicate corresponding parts throughout the several views. The exemplification set out herein illustrates an embodiment of the invention, in one form, and such exemplification is not to be construed as limiting the scope of the invention in any manner.

The drawings are only schematic and are non-limiting. In the drawings, the size of some of the elements may be exaggerated and not drawn on scale for illustrative purposes.

Any reference signs in the claims shall not be construed as limiting the scope. In the drawings, the same reference signs refer to the same or analogous elements.

The terms “front”, “rear”, “forward”, “rearward”, “left” and “right” used throughout this description are determined with respect to the normal direction of travel of the machine in operation. However, they are not to be construed as limiting terms.

As is described in U.S. Pat. No. 7,878,557 to CNH America LLC, which is incorporated by reference herein in its entirety and for all purposes, a baler 20 is configured to output finished bales such as shown in FIG. 2. Turning first to FIG. 2, the bale shown to the right is a finished bale, whereas the bale shown to the left is an unfinished bale. The finished bale is secured and circumscribed by a loop 62 of twine. The loop 62 is made from two strands of binding material, i.e., one strand 64 along the normally top side of the bale and a second strand 66 along the normally bottom of the bale and its two opposite ends. The strands 64 and 66 thus fully circumscribe the bale and are circumferential complements of one another. Two knots 68 and 70 appear in the loop 62 at those locations where the strands 64 and 66 are substantially end-to-end.

To the left of the loop 62 is a partial bale which is in the process of being formed and that is at least partially circumscribed by a partial loop 62a. The top strand 64a emanates from a source of supply 72, while the bottom strand 66a emanates from an entirely separate, second source of supply 74. At the particular point in the sequence chosen for illustration, the knot 68a is in existence, and the bale is approaching that length where a needle 42 of baler 20 is ready to swing into operation and present the strands 64a and 66a to the knotter 40 to complete the second knot (not shown).

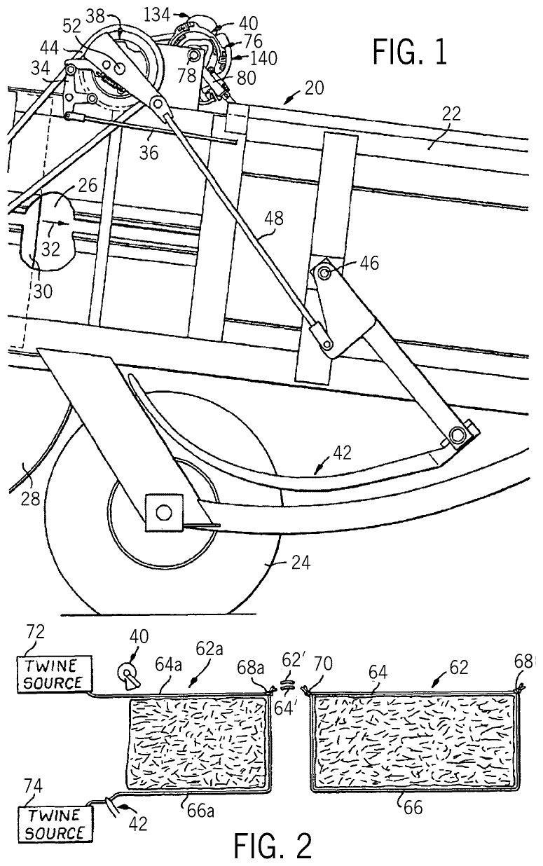

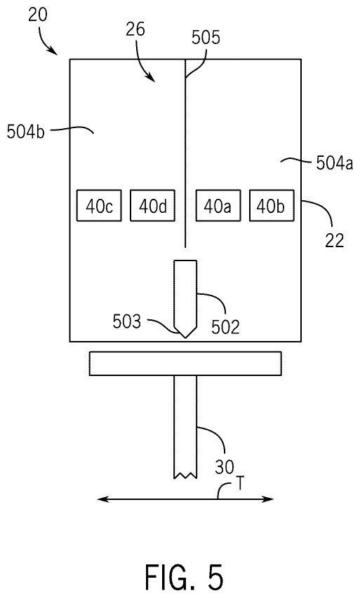

Turning back to FIG. 1, the details of baler 20 will be described. At the outset if should be understood that the baler 20 is not limited to the particular configuration that is shown and described and can vary greatly. Baler 20 generally comprises a rectangular bale case 22 that is supported for over-the-ground travel by one or more ground wheels 24. The bale case 22 defines a plurality of bale chambers 26 that happen to be loaded through a curved duct 28 approaching the case 22 from the bottom thereof. The multi-chamber aspect of baler 20 is addressed with reference to FIG. 5.

A plunger 30 reciprocates within the bale case 22 to intermittently pack fresh charges of material from the duct 28 rearwardly in the chambers 26 in the direction of the arrow 32. When the bale reaches a predetermined size, a trigger 34 is pulled by a rod 36 connected to a suitable bale length sensor (not shown) to engage a clutch 38 of a tying apparatuses of the baler. Baler 20 include four different tying apparatuses; however, the number of tying apparatuses can vary. Like the baler 20 itself, the tying apparatuses can vary greatly and are not limited to any of the details provided hereinafter.

Each tying apparatus is a sub-assembly generally including a clutch 38 (e.g., a dog clutch), a knotter 40 and a needle 42. For each tying apparatus, clutch 38 is mechanically connected to linkage 48 for moving the linkage 48 connected to needle 42, and clutch 38 is also mechanically connected to a drive shaft 78 of a knotter 40 for causing movement of that knotter, as will also be described below. Clutch 38 may be connected to drive shaft 78 by a belt, fastener or gear, for example.

The clutch 38 releasably connects one of the knotters 40 and its needle 42 to a source of driving power from the drive chain 44 to initiate the tying operation. Each clutch 38 may interact with a common drive shaft 52 that is driven by the drive chain 44, such that in the engaged state of one particular clutch 38, power is transferred by the common driven shaft 52 to both knotter 40 and needle 42 associated with that particular clutch 38. Alternatively, in the disengaged state of said one particular clutch 38, power is not transferred by the common driven shaft to both knotter 40 and needle 42 associated with that particular clutch 38.

As an alternative to using a clutch 38 that interacts with a common drive shaft 52 that is driven by the drive chain 44, those components may be replaced by an independently operated motor having an output shaft that delivers on-demand power to knotter 40 and needle 42. That motor may be powered by mechanical, electrical, pneumatic or hydraulic means, for example.

Referring now to one tying apparatus for the purpose of simplicity, the needle 42 is mounted on the bale case 22 by a pivot 46 and is swung back and forth across the bale chambers 26 by linkage 48 which becomes activated by the clutch 38. The needle 42 has an “at-home” or rest position fully below the bale case 22 as illustrated in FIG. 1 and a “full-throw” position extended completely across the bale case 22. The tip 50 of needle 42 has an eyelet in conjunction with a pair of longitudinally spaced, transversely extending rollers 58 and 60. It will be noted that the roller 58 is positioned inwardly from the outer extremity of the tip 50, while the roller 60 is positioned outwardly from the roller 58 more closely adjacent such extremity. Even so, the roller 60 is positioned a short distance inwardly from the outer extremity of the tip 50, and both of the rollers 58 and 60 may be tapered toward their mid points so as to provide secure seats for the tying strands as will later become apparent.

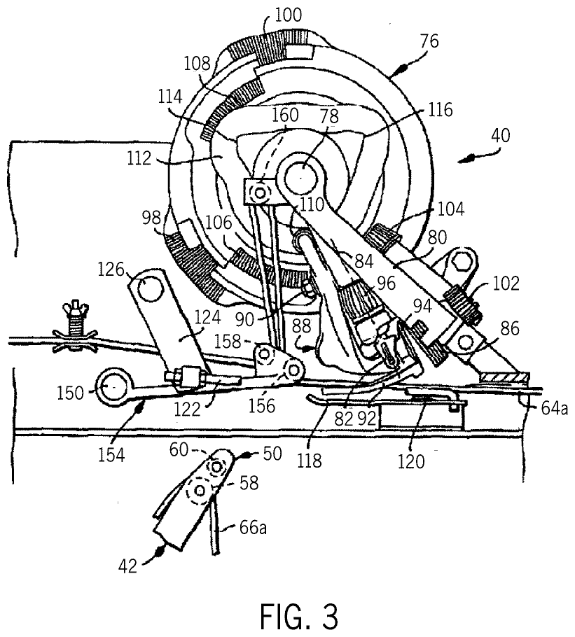

Turning now to FIGS. 1 and 3, the single knotter 40 shown in those figures includes a generally circular element 76 that is secured to a drive shaft 78 for rotation with the latter through one full revolution when the clutch 38 is engaged. The shaft 78 is supported by a forwardly inclined frame 80 attached to the top of the bale case 22, and the frame 80 also supports the above-mentioned components for forming the knots in response to rotation of the element 76.

Briefly, such components include a rotary bill hook member 82 supported by the frame 80 for rotation about an inclined axis 84, a multi-disc holder 86 rearwardly adjacent the bill hook 82 for holding strands 64a and 66a in position for engagement by the bill hook 82 during rotation of the latter, and means for releasing the connected strands from the holder 86 in the form of an arm 88 pivoted to the frame 80 by a bolt 90. The lower end of the arm 88 is forked, defining a crotch 92 that opens away from the holder 86 beneath the bill hook 82. The crotch 92 carries a cutter 94 between the bill hook 82 and the holder 86 for severing the strands 64a, 66a in response to swinging movement of the arm 88 in the proper direction. Such movement of the arm 88 to operate the cutter 94 also serves to engage the proximal areas of the crotch 92 with a knot formed on the bill hook 82 for stripping such knot off of the bill hook 82.

In order to transmit driving power from the element 76 to the bill hook 82, the latter is provided with a gear 96 which is disposed for meshing engagement with a pair of circumferentially spaced gear stretches 98 and 100 on the element 76. Similarly, driving power is transmitted to the discs of the holder 86 through a worm gear drive 102 and a bevel gear 104 in position for sequential meshing engagement with a pair of circumferentially spaced gear sections 106 and 108 on the element 76. Power to swing the arm 88 about the pivot bolt 90 is obtained through a cam follower 110 at the upper end of the arm 88 beyond the pivot bolt 90 which is disposed within a cam track 112 on the element 76. A pair of circumferentially spaced cam shoulders 114 and 116 in the track 112 are positioned to sequentially engage the follower 110 to operate the latter.

A finger 118 is located below the bill hook 82 and the crotch 92 of the knotter 40 and is mounted on an upright pivot 120 for lateral swinging movement between a standby position illustrated in FIG. 3 and a full-throw, laterally extended position. An operating link 122 attached at one end to the finger 118 and at the opposite end to a crank 124 serves to effect swinging of the finger 118.

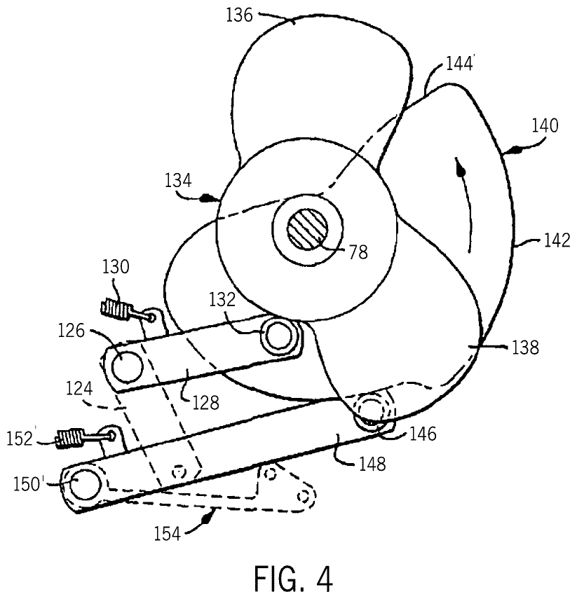

Turning now to FIG. 4, the crank 124 is in turn fixed to a transversely extending shaft 126 that extends to a point behind the element 76 where it carries a second crank 128. The second crank 128 is biased upwardly in a counterclockwise direction by a coil spring 130 and carries a cam follower 132 at its outermost end. The follower 132 is in position for operating engagement with a double-lobed cam 134 fixed to the shaft 78 for rotation therewith, the lobes 136 and 138 being circumferentially spaced apart in accordance with the desired timed relationship between the finger 118 and the knot-forming components of the knotter 40.

Also mounted on the shaft 78 with the cam 134 is a second cam 140 having a peripheral land stretch 142 over approximately 180 degrees of its circumference and a peripheral valley stretch 144 over the remaining approximately 180 degrees of its circumference. Such stretches 142 and 144 are disposed for operating engagement against a cam roller 146 located at the outer end of a lever 148 that is fixed at its inner end to a transverse shaft 150. The lever 148, and hence the shaft 150, is resiliently biased in a counterclockwise direction by a coil spring 152, and the shaft 150 extends back out to the opposite side of the element 76 in parallelism with the shafts 78 and 126 to a point substantially in fore-and-aft alignment with the bill hook 82.

Turning now to FIGS. 3 and 4, the shaft 150 fixedly carries a rearwardly extending slack take-up device 154. The device 154 carries a pair of spaced rollers 156 and 158 at its rearmost end around which the strand 64a is entrained as illustrated in FIG. 3. A length of the strand 64a is also looped upwardly around another roller 160 disposed above the device 154 and carried by the knotter frame 80 adjacent the drive shaft 78.

It should be understood that the above-described description of the tying apparatus can vary greatly and is not necessarily limited to the any of the aforementioned details.

Turning now to FIG. 5, the baler 20 may be a small square baler having multiple bale chambers (two shown). More particularly, a crop splitting knife 502, in addition to optional interior wall 505, divides the interior of bale chamber 26 into two separate chambers 504a and 504b. The chambers 504a and 504b are disposed on opposite sides of crop splitting knife 502. It is noted that as an alternative, the baler may have multiple plungers (not shown) that are each assigned to one of the chambers 504a and 504b of the multi-chamber baler.

It should be understood that in multi-chamber baler 20, the bales in each chamber 504a and 504b may not be formed at the same rate due to non-uniform introduction of incoming crop along the transverse direction ‘T’ of that baler. Thus, the bales within those chambers will be ready for wrapping and tying at different times. For that reason, baler 20 includes at least one independently operated tying apparatus per bale chamber. In the example shown, two tying apparatuses are associated with the right-hand bale chamber 504a and two tying apparatuses are associated with the left-hand chamber 504b. Each tying apparatus includes the above-described clutch 38, knotter 40 (i.e., one of knotters 40a-40d) and needle 42.

The bale tying cycle for baler 20 may be as follows. One of the bale chambers (e.g., bale chamber 504a) is indicated as ‘full’ by a mechanical or electrical signal, for example, whereas the other bale chamber (e.g., bale chamber 504b) is not yet indicated as being full. Once bale chamber 504a is indicated as full, the trigger(s) 34 associated with bale chamber 504a cause engagement of the clutch(es) 38 associated with bale chamber 504a thereby connecting the clutch(es) 38 to the common shaft 52 being rotated by belt 44. The clutch(es) 38 associated with bale chamber 504a then transfer power to both the needles 42 and the knotters 40a and 40b that are associated with the full chamber 504a. The needles 42 associated with the full chamber 504a then insert the twine to the knotters 40a and 40b when the plunger 30 is at the correct phase of the cycle, whereas the needles 42 associated with the non-full chamber 504b remain stationary. The knotters 40a and 40b in the full bale chamber 504a grab the twine from the moving needles 42 and complete a knot to secure the bale in the chamber 504a, whereas the knotters 40c and 40d and needles 42 in the non-full bale chamber 504b do not move. The tying and knotting process was described above. A finished bale is ultimately outputted from full bale chamber 504a, whereas the incompletely formed bale in the non-full bale chamber 504b remains untied.

Alternatively, and according to a different embodiment, if all four needles 42 are connected together and move simultaneously, then the knotters 40c and 40d corresponding to the non-full chamber 504b can remain de-activated (using the above-described clutches 38) such that the knotters 40c and 40d in the non-full bale chamber 504b do not grab the twine from their corresponding moving needles 42. The needles 42 simply retract out of the non-full bale chamber 504b. It is noted that a tensioning mechanism may be present in the twine path for the non-full bale chamber which moves an arm to take up any slack twine which is created by inserting the needles 42 without forming a knot in the non-full bale chamber.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural baler comprising:
first and second bale chambers, wherein each bale chamber is capable of holding an individual bale of crop material;
a first tying apparatus assigned to the first chamber for tying and knotting a bale formed within the first chamber; and
a second tying apparatus assigned to the second chamber for tying and knotting a bale formed within the second chamber,
wherein the first and second tying apparatuses are configured to be operated independently so as to accomplish tying and knotting of the bales in the first and second bales chambers at different times.

2. The agricultural baler of claim 1, wherein each tying apparatus includes a clutch that is operatively connected to a knotter.

3. The agricultural baler of claim 2, wherein the clutches of the first and second tying apparatuses releasably engage a common drive shaft.

4. The agricultural baler of claim 3, wherein for each clutch, the clutch is moveable between a first state, in which the clutch or a component thereof is configured to be rotated by the common drive shaft, and a second state, in which the clutch of the component thereof is not configured to be rotated by the common drive shaft.

5. The agricultural baler of claim 1, wherein each bale chamber has a plurality of tying apparatuses assigned thereto.

6. The agricultural baler of claim 1, wherein the agricultural baler is a square baler.

7. The agricultural baler of claim 1, further comprising a bale case defining an interior space, wherein a knife is positioned within the interior region to divide the interior region into the first and second bale chambers.

8. The agricultural baler of claim 1, wherein a single plunger is configured to deliver crop material into both the first and second bale chambers.

9. The agricultural baler of claim 1, wherein a first plunger is assigned to the first bale chamber for delivering crop material into the first bale chamber, and a second plunger is assigned to the second bale chamber for delivering crop material into the second bale chamber.

10. A method of operating an agricultural baler, wherein the agricultural baler includes (i) first and second bale chambers, wherein each bale chamber is capable of holding an individual bale of crop material, (ii) a first tying apparatus assigned to the first chamber for tying and knotting a bale formed within the first chamber, and (iii) a second tying apparatus assigned to the second chamber for tying and knotting a bale formed within the second chamber, said method comprising:
independently operating the first and second tying apparatuses to accomplish tying and knotting of the bales in the first and second bales chambers at different times.

11. The method of claim 10, wherein each tying apparatus includes a clutch that is operatively connected to a knotter.

12. The method of claim 11, wherein the clutches of the first and second tying apparatuses releasably engage a common drive shaft.

13. The method of claim 12, wherein for each clutch, the clutch is moveable between a first state, in which the clutch or a component thereof is configured to be rotated by the common drive shaft, and a second state, in which the clutch of the component thereof is not configured to be rotated by the common drive shaft.

14. The method of claim 10, wherein the baler includes (i) a bale case defining an interior space, and (ii) a knife positioned within the interior region to divide the interior region into the first and second bale chambers, and the method comprises delivering crop material into the interior space and past the knife such that one portion of the crop material is split by the knife and delivered into the first bale chamber and a remaining portion of the crop material is split by the knife and delivered into the second bale chamber.

15. The method of claim 10, the method further comprising using a first plunger assigned to the first bale chamber for delivering crop material into the first bale chamber, and using a second plunger assigned to the second bale chamber for delivering crop material into the second bale chamber.
